(19) United States
(12) Patent Application Publication
(10) Pub. No.: US 2026/0106800 A1
(43) Pub. Date: Apr. 16, 2026

(54) SYSTEMS AND METHODS FOR AN INTELLIGENT NETWORK CONFIGURATION CAPABILITY (INCC) FOR MESH NETWORKS

(71) Applicant: NORTHROP GRUMMAN SYSTEMS CORPORATION, Falls Church, VA (US)

(72) Inventors: Robert Elwell, San Diego, CA (US); Justin Femino, San Diego, CA (US)

(73) Assignee: NORTHROP GRUMMAN SYSTEMS CORPORATION, Falls Church, VA (US)

(21) Appl. No.: 18/914,877

(22) Filed: Oct. 14, 2024

(51) Int. Cl. H04L 41/12; H04W 84/18

(52) U.S. Cl. CPC H04L 41/12; H04W 84/18

(57) ABSTRACT

The Intelligent Network Configuration Capability (INCC) selects and establishes efficacious links in a sparse dynamic wireless mesh network comprising a plurality of mobile devices. When a new node or network joins an existing wireless mesh network, a coordinator node is selected (from each wireless mesh network network) and information is exchanged with the new node or wireless mesh network via an interim link. The INCC determines which nodes should be linked at the successful completion of the joining process. The coordinator node then establishes the new links between the nodes to complete the joining process. The updated network topology is stored by the coordinator node in a network topology database.

### FIELD OF THE INVENTION

The present invention provides an Intelligent Network Configuration Capability (INCC) for selecting and establishing efficacious links in a sparse dynamic wireless mesh network comprising a plurality of mobile devices.

### BACKGROUND

A wireless mesh network consists of a collection of nodes that connect directly, dynamically, and non-hierarchically to each other to provide a communication conduit between any two nodes in the network. Mesh networks in which nodes are mobile (e.g., mobile devices that regularly change coordinates) must accommodate frequent network topology changes that occur when nodes join and leave the network as well as when nodes establish and drop links with each other.

Individual nodes in a fully connected mesh network have direct links to every other node in the network. In a partially connected mesh network, each node is linked to at least one other node, but not necessarily to every node in the network. Certain design considerations (e.g., limited node capability, low probability of detection/intercept) may restrict the maximum number of links that a node is allowed to establish, resulting in a sparsely connected network.

Network efficacy is largely dependent on the network topology when it is partially/sparsely connected. Significant performance benefits often are realized by establishing direct links between specific nodes (e.g., nodes belonging to the same operational group) and accounting for factors that affect network reliability (e.g., range between connected nodes).

Absent any constraints, mesh network nodes connect haphazardly to form a network. Therefore, there exists a need for systems and methods of deliberately determining how a node connects to a partially/sparsely connected network that would significantly improve network efficacy. The Intelligent Network Configuration Capability (INCC) of the present invention has been conceived to serve this purpose.

### SUMMARY

The present invention provides an Intelligent Network Configuration Capability (INCC) for selecting and establishing efficacious links in a sparse dynamic wireless mesh network comprising a plurality of mobile devices. When a new node or network joins an existing wireless mesh network, a coordinator node is selected (from each wireless mesh network network) and information is exchanged with the new node or wireless mesh network via an interim link. The INCC determines which nodes should be linked at the successful completion of the joining process. The coordinator node then establishes the new links between the nodes to complete the joining process. The updated network topology is stored by the coordinator node in a network topology database.

### BRIEF DESCRIPTION OF THE DRAWINGS

FIG. 1 depicts an exemplary wireless mesh network.

FIG. 2 depicts an example of a new node joining the wireless mesh network of FIG. 1.

FIG. 3 depicts the new node of FIG. 2 joining an existing group.

FIG. 4 depicts an example of two new nodes joining a wireless mesh network of FIG. 1.

FIG. 5 depicts an example of a joining position selection function.

FIG. 6 depicts an example of a convolutional neural network (CNN) performing image recognition.

FIG. 7 depicts an exemplary system diagram for the INCC system architecture according to an embodiment of the invention.

FIG. 8 depicts a flowchart showing the steps used by the INCC when one or more nodes joins another wireless mesh network.

FIG. 9 depicts a flowchart showing the steps used by the INCC when one or more nodes leaves a wireless mesh network.

FIG. 10 depicts an example wireless mesh network with node encodings.

FIG. 11 depicts an example of the INCC implemented using a GNN according to an embodiment of the invention.

FIG. 12 depicts an example of an INCC-equipped wireless mesh network having new nodes join.

FIG. 13 depicts a combined wireless mesh network of FIG. 11 after the INCC has decided on a joining position for the new nodes.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

The embodiments disclosed herein are for the purpose of providing a description of the present subject matter, and it is understood that the subject matter may be embodied in various other forms and combinations not shown in detail. Therefore, specific embodiments and features disclosed herein are not to be interpreted as limiting the subject matter as defined in the accompanying claims.

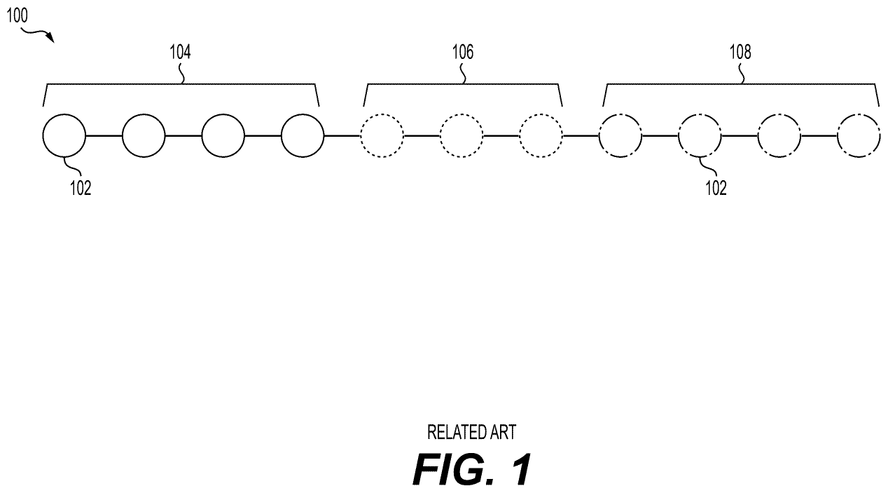

For a better understanding of the present invention, first consider an open-ended wireless mesh network 100 comprising a plurality of nodes 102 that link with at most two other nodes as depicted in FIG. 1. Each node 102 is statically assigned to an operational group 104, 106 or 108 (differentiated in FIG. 1).

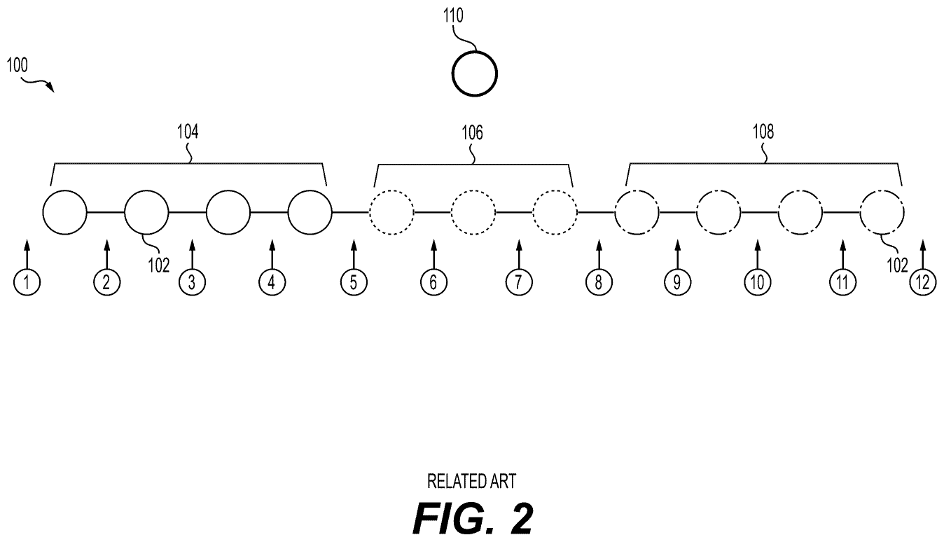

A new node 110 could join the existing wireless mesh network 100 in any one of twelve possible positions as depicted in FIG. 2. Here, the new node 110 is not part of any of the operational groups. However, it may be advantageous to maintain direct links between nodes assigned to the same operational groups 104, 106, or 108. In which case, the new node 110 should be constrained to only join wireless mesh network 100 at position 1, 5, 8 or 12. It may also be desirable to minimize the physical distance between linked nodes 102. The decision whether to join at position 1, 5, 8 or 12 would then be determined based on which one of those positions results in the shortest link distances to the new node 110.

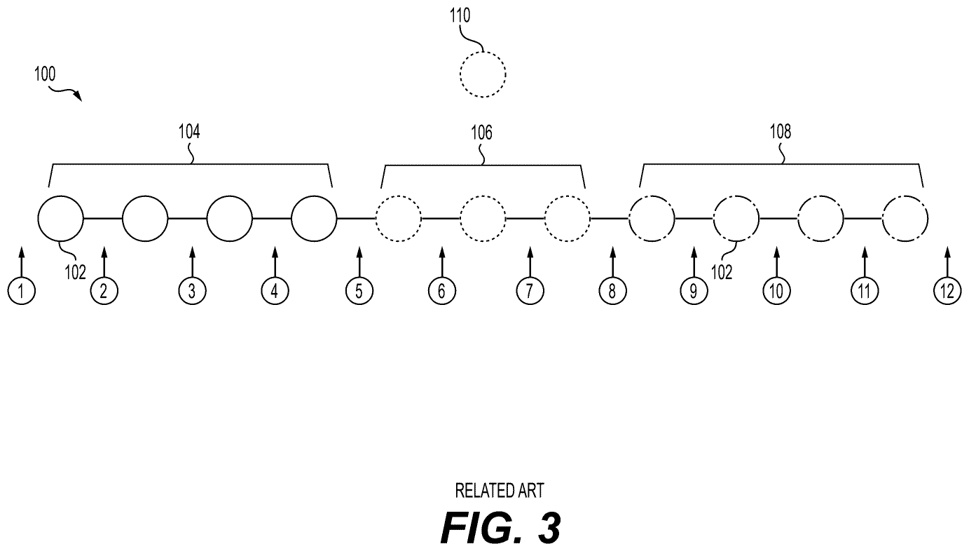

A slight change to the new node joining scenario occurs when the new node 110 (FIG. 3) is functionally part of an existing operational group 104, 106, or 108. Here, new node 110 is part of operational group 106. This triggers a very different decision path for choosing the joining position. Preserving direct links between nodes 102 belonging to the same group dictates that the new node 110 now only joins at position 5, 6, 7 or 8. Otherwise, new node 110 would be a member of the other operation groups 104 or 108. Physical link distance would again determine which of those four positions is selected.

The examples of FIGS. 1-3 illustrate that even wireless mesh networks 110 comprised of a relatively small number of nodes (e.g., ten nodes with three operational groups) have a multitude of diverse potential joining scenarios.

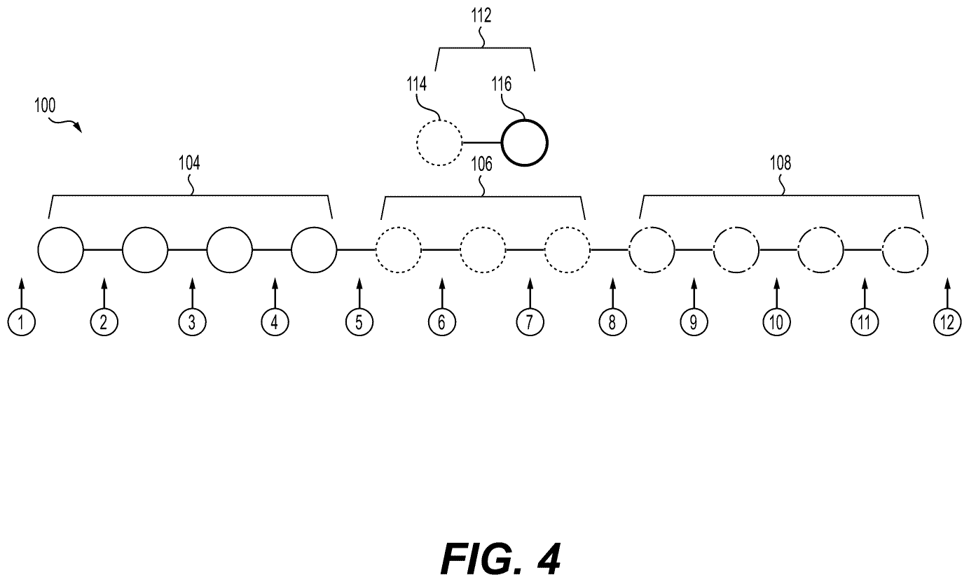

In addition to single nodes joining an existing network, scenarios involving two networks joining each also regularly need to be considered. FIG. 4 depicts a joining scenario where the new wireless mesh network 112 is joining with wireless mesh network 100. First node 114 is part of operational group 106 whereas second node 116 is not part of any operational group. In resolving the situation shown in FIG. 4, the group constraint leaves only one choice for the joining position (i.e., position 8) for new wireless mesh network 112 and link distance does not come into play.

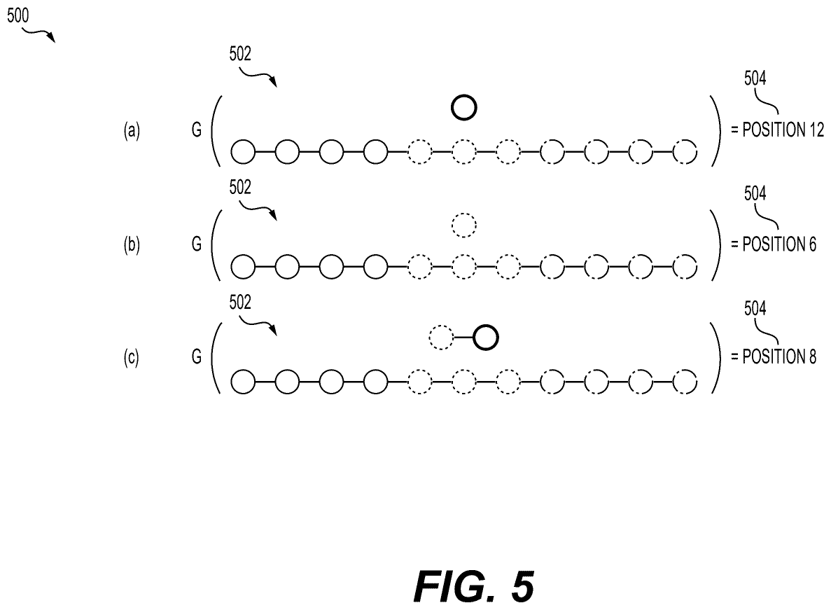

The joining position selection function in herein referred to as a function, G(X) 500, that takes the joining scenario as the input, X (e.g., the wireless mesh network 100 and new node 110) 502, and outputs the desired joining position outcome 504 as depicted in FIG. 5. The joining position outcomes to FIGS. 2-4 are depicted in (a)-(c) of FIG. 5, respectively.

The joining position selection function 500 can be implemented using a conventional algorithmic approach to determine joining position outcome 504. However, algorithm complexity would grow exponentially based on numerous factors (e.g., network node capacity, node link capacity, number of selection constraints) and would quickly become impractical for all but the most rudimentary situations.

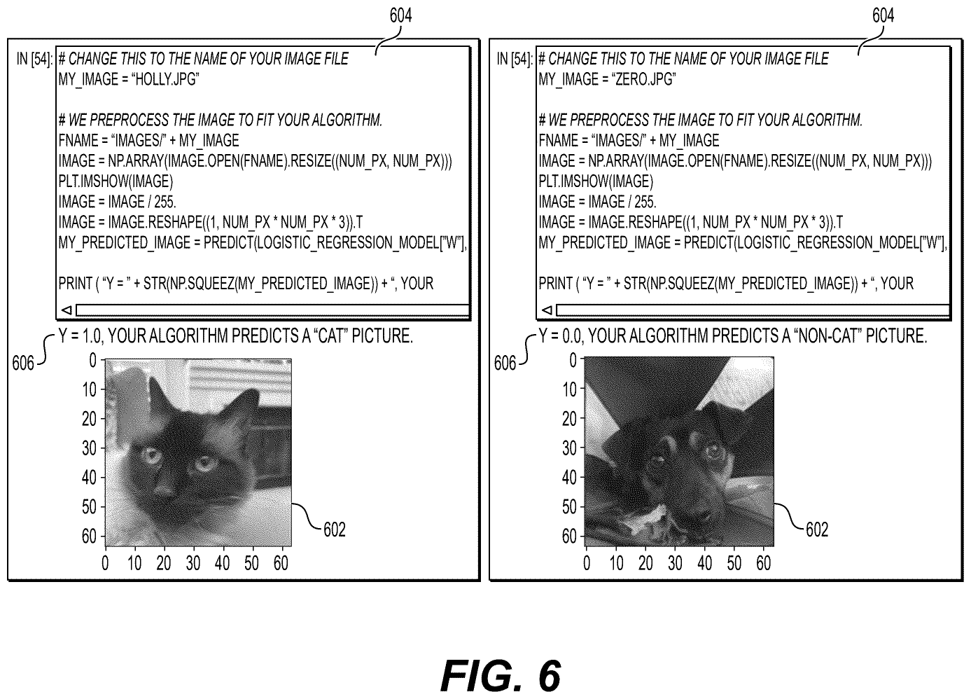

An alternative approach utilized in the present invention is to leverage neural networks. Neural networks provide the means to empirically derive approximations for functions like the joining position selection function, G(X) 500, posited above. For example, a convolutional neural network (CNN) can take a collection of pixel values arranged in a grid as input 602 and apply a derived prediction function 604 to “recognize” the contents of the image that those pixel values represent and produce output 606 (FIG. 6). Likewise, a recurrent neural network (RNN) can take a stream of digitized audio data and “recognize” the spoken words in it (e.g., speech to text algorithms).

A graph neural network (GNN) processes information represented as a set of nodes and the connections between those nodes. A variety of real-world entities (e.g., molecules, social networks, research citations, communication networks) can be represented as graphs. A GNN can be constructed to predict characteristics about a whole graph, about the attributes of individual nodes, or about the nature of connections between the nodes in the input graph. The INCC of the present invention exploits the capability of GNNs to “recognize” network connection characteristics to provide a robust instantiation of the joining position selection function, G(X). That is, the GNN calculates an accurate representation of the solution that would be produced by the conventional algorithmic approach and produce the same output as FIG. 5 in far less time.

A mesh network can employ the INCC whenever an event occurs that causes an impending change to the network topology. Such events include a node or network of nodes joining an existing mesh network (e.g., FIGS. 1-4); a node or subset of nodes departing the mesh network; and the loss of a link between nodes within the mesh network.

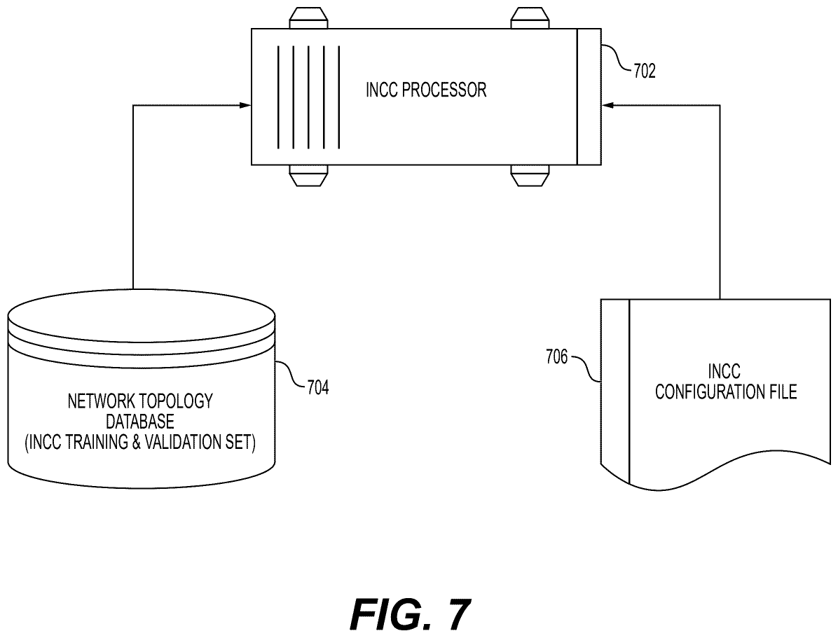

FIG. 7 depicts a system diagram of INCC 702 showing its primary components. The programming for INCC 702 is generally executed on a processor with accompanying memory (e.g., random access, solid state, etc.) as is known in the art. The INCC 702 can be executed on a local machine with a processor, like a server, or can utilize distributed processing architecture as is known in the art. The INCC 702 stores the network topology of the various configured networks in network topology database 704. Whenever the network configuration changes, the topology is updated in network topology database 704. INCC configuration file 706 generally stores the parameters used for joining or leaving the various networks and what considerations should be prioritized (e.g., which node should be the coordinator node, etc.).

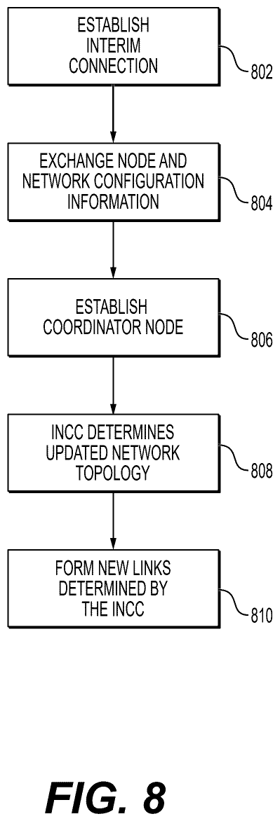

FIG. 8 depicts a flowchart showing the steps utilized by the INCC 702 in the event a network of one or more nodes is to join another mesh network. For example, in FIG. 4, the INCC 702 could be utilized to determine how new wireless mesh network 112 is joined to existing wireless mesh network 100.

The INCC 702 utilizes the steps depicted in FIG. 8., the following fundamental steps would occur. First, one node from each network 100 and 112 establishes an interim connection (e.g., any node 102 and node 114/116) in step 802. The connecting nodes exchange pertinent node and network configuration information in step 804. For example, the pertinent node and network configuration information may include network topology, operational groups, distance limits, or any other considerations to be used when determining a joining position.

After step 804, one of the connecting nodes assumes the role of coordinator node in step 806. The coordinator node may be determined based on one or more criterion established a priori in the INCC design. For example, the number of nodes in each connecting network could be compared and the connecting node in the network with the larger number of constituent nodes could be designated as the coordinator node. In another case, the INCC 702 could maintain a prioritized list of organizational groups and designate the connecting node belonging to the organization group with higher priority to be the coordinator node. In a different approach, a separate neural network could be trained to determine the coordinator node.

The coordinator node uses the INCC 702 to determine which nodes should be linked at the successful completion of the joining process in step 808. That is, the INCC 702 is used as the function 500 for determining the joining position outcome(s) 504 uses the wireless mesh networks as inputs 502 as has already been described.

New links determined by the INCC 702 are established by the coordinator node in step 810, thereby assimilating the two networks into a single network with an advantageous topology. The configuration information exchanged in step 804 is used as the input 502 to the GNN 702 that is at the heart of the INCC 702. In the examples already discussed, the configuration information would include operational group membership and position of every node in the two networks (e.g., in FIG. 4).

A node or subset of nodes volitionally leaving a network or the loss of a link between two nodes in the network could result in the need to rearrange the network topology. For example, the event could put the remaining network asunder. New links would need to be initiated to reestablish connectivity between all nodes. In this case, the INCC 702 would identify which links should be established to ensure the resulting network topology is favorable.

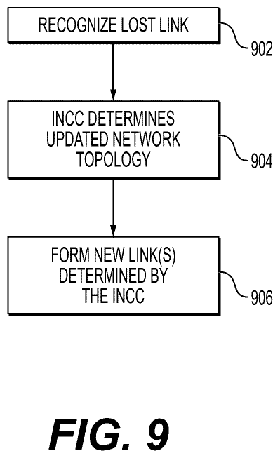

FIG. 9 depicts a flowchart used by INCC 702 when a node is lost or leaves the network. When the INCC recognizes that that a link that had been established with another node has now been lost in step 902, the INCC 702 determines whether the lost link should be replaced by establishing a new link with a node other than the node that had been previously linked. The node in the wireless mesh network that recognizes the loss of the link assumes the role of a coordinating node. Since the node is already aware of all of the network and node configuration information processed by the INCC 702, there is no need to exchange that information with any other node. The INCC 702 determines an updated network topology in step to replace the lost link. The coordinator node proceeds to establish the new link in step 906 and the network topology database 704 is updated accordingly.

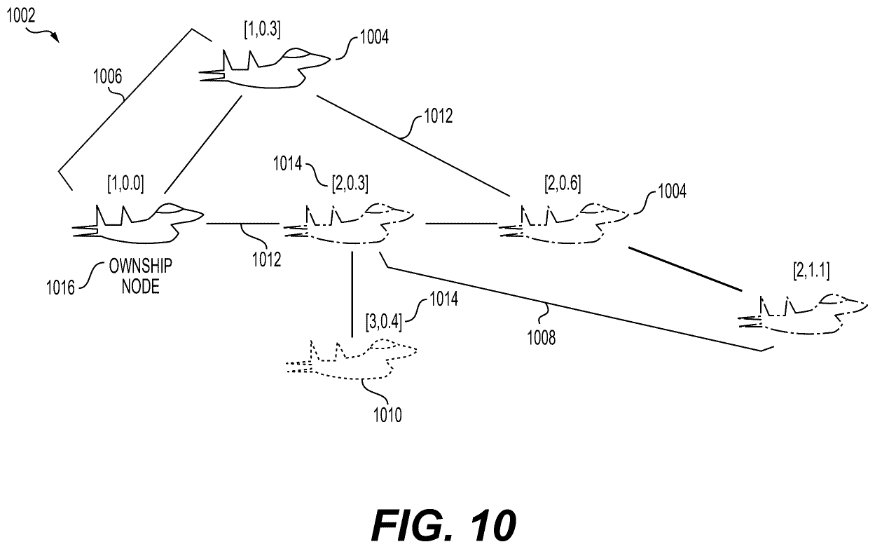

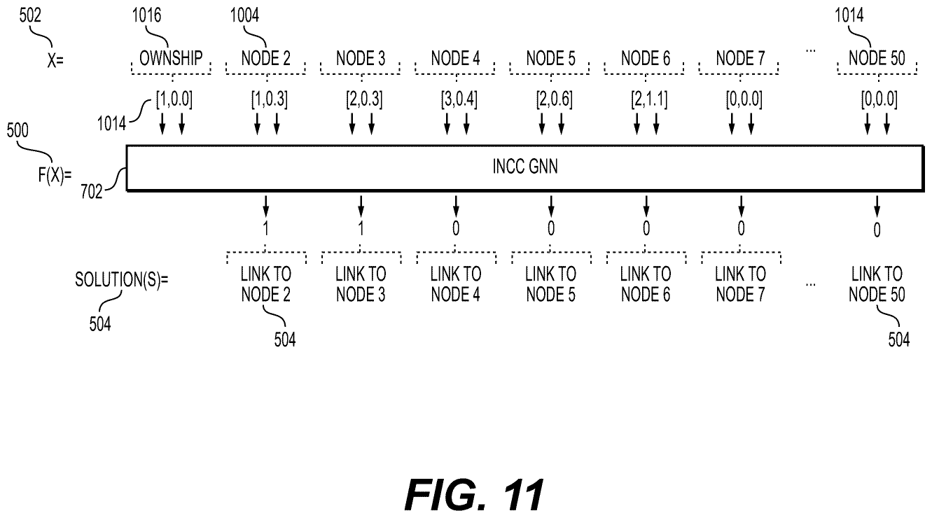

Referring next to FIGS. 10-13, described is an example of a mesh network 1002 that enables communication between up to 50 aircraft 1004 (nodes), where each aircraft 1004 can connect with a maximum of four other aircraft in the mesh network 1004. Each aircraft 1004 in the mesh network 1002 is assigned to one and only one organizational group 1006, 1008, or 1010. While it is feasible for any aircraft 1004 to establish a link with any other aircraft 1004 in an ad hoc fashion, network efficacy is significantly improved by adhering to the predetermined operational conditions:
Priority is given to establishing links between aircraft 1004 assigned to the same organizational group.
Each aircraft 1004 is limited to establishing no more than one link with an aircraft 1004 assigned to a different group.
Links are not established between aircraft 1004 that are more than one mile apart.

In a preferred embodiment, each aircraft 1004 is equipped with the INCC 702 and can assume the functionality of a coordinator node. For INCC purposes, the communication network is treated as a sparsely connected graph, where each aircraft 1004 is represented by a graph node and each link between aircraft is represented as an edge 1012 between the corresponding nodes in the graph.

In the example of FIG. 10, the INCC 702 encodes the pertinent characteristics 1014 of each node (aircraft 1004) as a couplet denoted by [Group, Distance], where Group is the aircraft's group organizational group (e.g., 1006, 1008, or 1010) and Distance is the physical distance to the node from a particular INCC's 702 ownship node 1016 (e.g., established coordinator node). For example, a node designated by [2, 0.3] belongs to organizational group 2 (1008) and is located 0.3 miles away from ownship node 1016. FIG. 10 depicts a mesh network 1002 having five aircraft 1004 with their node encodings 1014.

The node encodings 1014 for all known nodes are the inputs 502 to the GNN used by INCC 702 (FIG. 8). The GNN output 504 are Boolean indicators whether a link should be established between ownship node 1016 and each other node 1004.

Alternatively, the INCC 702 can be implemented using a GNN that takes the encodings for ownship node 1016 and a single other node (e.g., any other aircraft 1004) as inputs and then outputs a single Boolean indicator 504. In this case, INCC 702 could use this GNN implementation to iterate over all known nodes in the environment one at a time.

Prior to deployment, the INCC GNN 702 would be trained to recognize the links that ought to be established based on the network efficacy constraints that have been delineated and then validated. Training would be accomplished using positive and negative samples generated from the graph(s) representing one or more network examples that posit all efficacy constraints 1014. An advantage of utilizing a GNN is that the training data can be produced from much smaller network examples (e.g., 5-10 nodes), but the resulting trained INCC GNN 702 can be utilized for much larger network examples (e.g., 50+ nodes).

Adding or changing efficacy constraints 1014 would entail retraining and revalidating the INCC GNN 702. If the constraint changes are dependent on new node characteristics, then it would be necessary to modify the INCC GNN 702 to accommodate the node encodings 1014 for those characteristics. For example, if one aircraft 1004 in each organizational group is designated as lead and links between lead aircraft are prioritized, then another parameter would be added to each node's encoding 1014 to characterize the lead aircraft designation.

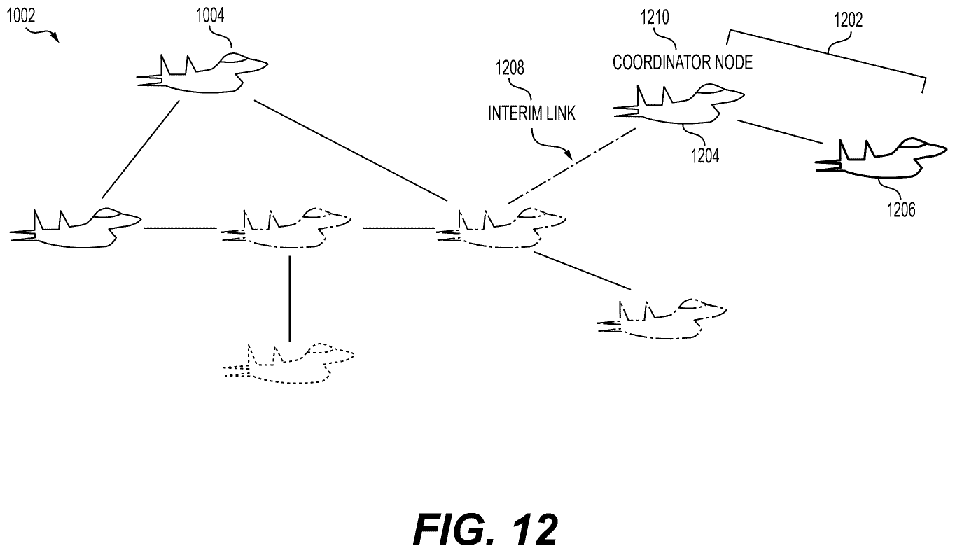

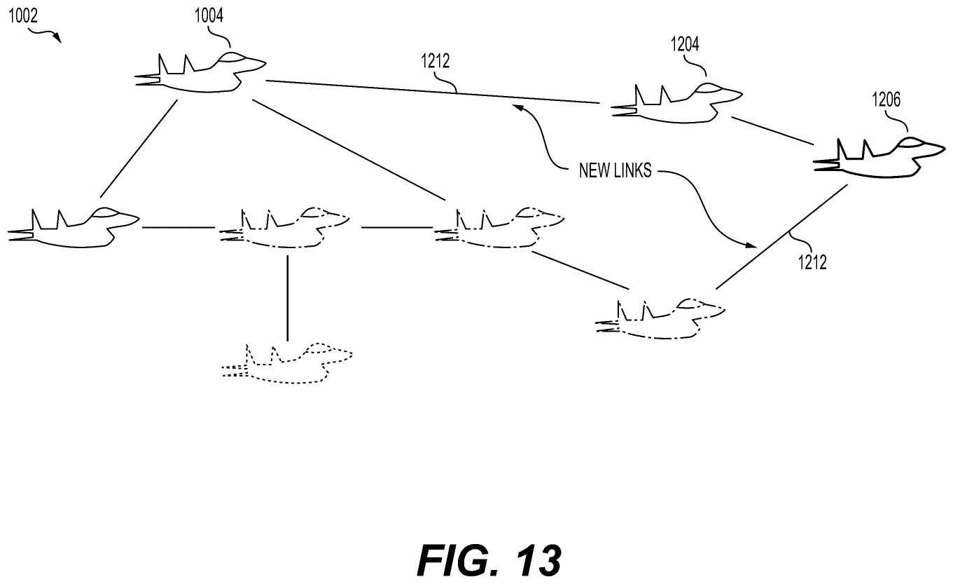

FIG. 12 depicts an example when a mesh network 1202 formed from two airplanes 1204 and 1206 are attempting to join the mesh network of FIG. 10. One node in each network connects to each other via an interim link 1208 (step 802), exchange pertinent information describing each network (step 804), and designate one node as coordinator node 1210 (step 806). The INCC 702 here determines (solutions 504) that maintaining the interim link 1208 is not conducive to network efficacy. The INCC 702 drops the interim link 1208 and establishes two new links 1212 between other nodes as depicted in FIG. 13.

While specific embodiments of the invention have been described above, it will be appreciated that the invention may be practiced other than as described. The embodiment(s) described, and references in the specification to “one embodiment,” “an embodiment,” “an example embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

1. A method for joining a first wireless mesh network to a second wireless mesh network utilizing an Intelligent Network Configuration Capability (INCC), the method comprising:
selecting, by the INCC, a first coordinator node from the first wireless mesh network;
selecting, by the INCC, a second coordinator node from the second wireless mesh network;
forming an interim connection between the first coordinator node and the second coordinator node;
exchanging pertinent node and network configuration information between the first coordinator node and the second coordinator node;
determining, by the INCC, an updated network topology for joining the first wireless mesh network and the second wireless mesh network using a joining position function,
wherein the joining position function is a graph neural network (GNN) having an input of node encodings for each node in the first wireless mesh network and the second wireless mesh network; and
forming, under control of the first coordinator node or the second coordinator node, a combined wireless mesh network using the updated network topology to join the first wireless mesh network to the second wireless mesh network; and
storing the updated network topology in a network topology database.

2. The method according to claim 1, wherein the pertinent node and network configuration information includes network topology, operational groups, distance limits, or joining considerations.

3. The method according to claim 1, wherein output of the GNN are Boolean indicators indicating, for each node in the first wireless mesh network and the second wireless mesh network, whether a link should be formed with other nodes in the first wireless mesh network or the second wireless mesh network.

4. The method according to claim 1, wherein the GNN is trained on training data having less inputs than nodes in the first wireless mesh network or the second wireless mesh network.

5. The method according to claim 4, wherein the training data is produced by a joining position function using a conventional algorithmic approach to produce an exact solution.

6. The method according to claim 1, further comprising:
monitoring, by the first coordinator node, the combined wireless mesh network;
detecting any changes in the updated network topology; and
if any changes in the updated network topology are detected, determining, by the INCC, a second updated network topology, and
reconfiguring the combined wireless mesh network using the second updated network topology.

7. The method according to claim 6, wherein the change in the updated network topology includes at least one node leaving the combined wireless mesh network.

8. The method according to claim 7, wherein if the at least one node leaving was a most recent coordinator node, selecting a new coordinator node that was a second most recent coordinator node.

9. The method according to claim 6, wherein the change in the updated network topology includes at least one node attempting to join the combined wireless mesh network.

10. The method according to claim 1, wherein the INCC stores the pertinent node and network configuration information in association with an identifier for the combined wireless mesh network in an INCC configuration file.

11. The method according to claim 1, wherein the INCC stores a listing of all coordinator nodes and associated timestamps,
wherein the INCC selects as the first coordinator node a most recent coordinator node from the listing of all coordinator nodes.
